(19) United States
(12) Patent Application Publication
(10) Pub. No.: US 2025/0368307 A1
(43) Pub. Date: Dec. 4, 2025

(54) SOLAR CHARGING SYSTEM FOR WATERCRAFT

(71) Applicant: YAMAHA HATSUDOKI KABUSHIKI KAISHA, Iwata-shi (JP)

(72) Inventor: Yuta MIYAGI, Shizuoka (JP)

(21) Appl. No.: 19/214,151

(22) Filed: May 21, 2025

(30) Foreign Application Priority Data
May 28, 2024 (JP) 2024-086258

(51) Int. Cl. B63H 21/17; H02J 7/00; H02J 7/35

(52) U.S. Cl. CPC B63H 21/17; H02J 7/0048; H02J 7/00712; H02J 7/35; B63H 2021/171

(57) ABSTRACT

A solar charging system for a watercraft includes a solar panel, a battery, an electric charger, a switch, and a battery monitor. The solar panel is attached to the watercraft. The electric charger is connected to the battery. The switch is separate from the electric charger. The switch is connected to the electric charger and the solar panel. The switch is configured to switch between whether or not to electrically charge the battery in accordance with a status of the battery. The battery monitor is configured to monitor the status of the battery and control the switch in accordance with the status of the battery.

### CROSS REFERENCE TO RELATED APPLICATIONS

This application claims the benefit of priority to Japanese Patent Application No. 2024-086258 filed on May 28, 2024. The entire contents of this application are hereby incorporated herein by reference.

### BACKGROUND OF THE INVENTION

### 1. Field of the Invention

The present invention relates to solar charging systems for watercraft.

### 2. Description of the Related Art

A type of solar charging system for a watercraft has been known in which a battery is charged by electric power generated by a solar panel in the watercraft. The battery and the solar panel are connected through an electric charger as disclosed in, for instance, Japan Utility Model Registration No. 3150986.

In the type of solar charging system described above, the electric charger converts the electric power generated by the solar panel from direct current (DC) to alternating current (AC) and supplies the DC-to-AC converted electric power to the battery so as to electrically charge the battery. In this case, excessive charging or degradation of the battery is a concern. There is a type of electric charger with a function of monitoring the status of a battery to prevent excessive charging or degradation of the battery. However, this type of electric charger is expensive.

### SUMMARY OF THE INVENTION

Example embodiments of the present invention provide solar charging systems for watercraft that prevent excessive charging or degradation of batteries at low cost.

A solar charging system for a watercraft according to an example embodiment of the present invention includes a solar panel, a battery, an electric charger, a switch, and a battery monitor. The solar panel is attached to the watercraft. The electric charger is connected to the battery. The switch is separate from the electric charger. The switch is connected to the electric charger and the solar panel. The switch is configured to switch between whether or not to electrically charge the battery in accordance with a status of the battery. The battery monitor is configured to monitor the status of the battery and control the switch in accordance with the status of the battery.

According to example embodiments of the present invention, the status of the battery is monitored by the battery monitor. Then, the switch is controlled to switch between whether or not to electrically charge the battery in accordance with the status of the battery. Accordingly, excessive charging or degradation of the battery is prevented. Additionally, the switch is separate from the electric charger. Because of this, excessive charging or degradation of the battery can be prevented at a low cost without using an expensive electric charger.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view of a watercraft in which a solar charging system according to an example embodiment of the present invention is provided.

FIG. 2 is a diagram showing a configuration of the solar charging system.

FIG. 3 is a diagram showing a configuration of a solar charging system according to another example embodiment of the present invention.

### DETAILED DESCRIPTION OF THE EXAMPLE EMBODIMENTS

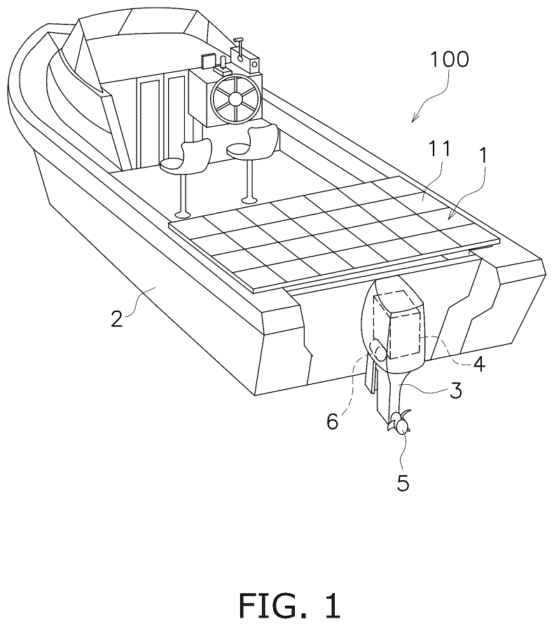

Solar charging systems according to example embodiments of the present invention will be explained with reference to drawings. FIG. 1 is a perspective view of a watercraft 100 in which a solar charging system 1 according to an example embodiment is provided. As shown in FIG. 1, the watercraft 100 includes a hull 2 and an outboard motor 3. The outboard motor 3 is attached to the hull 2. The outboard motor 3 generates a thrust to cause the watercraft 100 to navigate. The outboard motor 3 includes an engine 4, a propeller 5, and an electric power generator 6. The engine 4 generates a driving force to rotate the propeller 5. The electric power generator 6 generates electric power by the driving force of the engine 4.

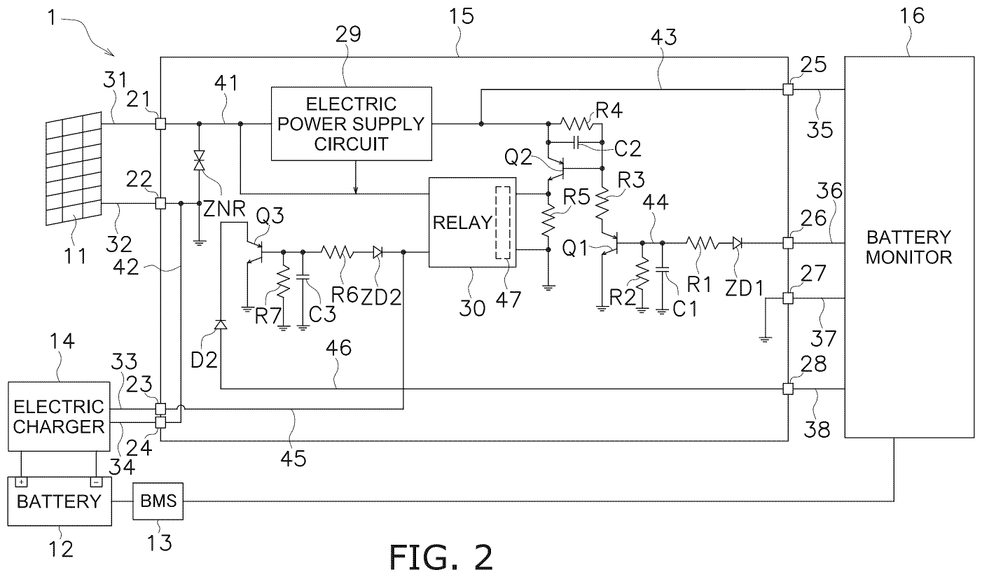

FIG. 2 is a diagram showing a configuration of the solar charging system 1. As shown in FIG. 2, the solar charging system 1 includes a solar panel 11, a battery 12, a battery management system (hereinafter referred to as “BMS”) 13, an electric charger 14, a switch 15, and a battery monitor 16. The solar panel 11 is attached to the watercraft 100. The solar panel 11 generates electric power by sunlight.

The battery 12 is charged with the electric power generated by the solar panel 11. The battery 12 may be, for instance, a secondary cell such as a lithium ion battery. The BMS 13 is connected to the battery 12. The BMS 13 detects the status of charging (SOC) of the battery 12. The electric charger 14 is connected to the battery 12. The electric charger 14 is connected to the solar panel 11 through the switch 15. The electric charger 14 reduces the voltage of the electric power generated by the solar panel 11.

The switch 15 is separate from the electric charger 14, i.e., the switch 15 is a separate element or device than the electric charger 14. The switch 15 is connected to the electric charger 14 and the solar panel 11. The switch 15 is configured to switch between whether or not to electrically charge the battery 12 in accordance with the status of the battery 12. More specifically, the switch 15 includes a positive polarity electric charging input terminal 21, a negative polarity electric charging input terminal 22, an electric charging output terminal 23, an electric charging ground terminal 24, an electric power supply output terminal 25, a control input terminal 26, a control ground terminal 27, an electric charging monitoring terminal 28, an electric power supply circuit 29, and a relay 30.

The positive polarity electric charging input terminal 21 and the negative polarity electric charging input terminal 22 are connected to the solar panel 11 through harnesses 31 and 32, respectively. The electric charging output terminal 23 and the electric charging ground terminal 24 are connected to the electric charger 14 through harnesses 33 and 34, respectively. The electric power supply output terminal 25, the control input terminal 26, the control ground terminal 27, and the electric charging monitoring terminal 28 are connected to the battery monitor 16 through harnesses 35 to 38, respectively.

The switch 15 includes an electric charging input circuit 41 and an electric charging ground circuit 42. The positive polarity electric charging input terminal 21 is connected to the electric power supply circuit 29 and the relay 30 through the electric charging input circuit 41. The negative polarity electric charging input terminal 22 is connected to the electric charging ground terminal 24 through the electric charging ground circuit 42. The electric charging input circuit 41 is connected to the electric charging ground circuit 42 through a varistor ZNR.

The switch 15 includes an electric power supply output circuit 43 and a switching control circuit 44. The electric power supply circuit 29 is connected to the electric power supply output terminal 25 through the electric power supply output circuit 43. The control input terminal 26 is connected to the electric power supply circuit 29 and the relay 30 through the switching control circuit 44. A Zener diode ZD1, resistors R1 to R5, capacitors C1 and C2, and transistors Q1 and Q2 are connected to the switching control circuit 44.

The switch 15 includes an electric charging output circuit 45 and an electric charging monitoring circuit 46. The electric charging output terminal 23 is connected to the relay 30 through the electric charging output circuit 45. The electric charging monitoring terminal 28 is connected to the electric charging output circuit 45 through the electric charging monitoring circuit 46. A Zener diode ZD2, resistors R6 and R7, a capacitor C3, a transistor Q3, and a diode D2 are connected to the electric charging monitoring circuit 46.

The electric power supply circuit 29 supplies electric power to drive the battery monitor 16 with the electric power generated by the solar panel 11. The relay 30 may be, for instance, a semiconductor relay such as an SSR (Solid State Relay). The relay 30 is switchable between on and off. When switched on, the relay 30 allows electric connection between the electric charging input circuit 41 and the electric charging output circuit 45. When switched off, the relay 30 shuts off the electric connection between the electric charging input circuit 41 and the electric charging output circuit 45. The relay 30 includes a drive circuit 47. When the drive circuit 47 is supplied with voltage, the relay 30 is switched on. When the drive circuit 47 is not being supplied with voltage, the relay 30 is switched off.

The battery monitor 16 is separate from the electric charger 14. The battery monitor 16 is separate from the switch 15. As described above, the battery monitor 16 is connected through the harnesses 35 to 38 to the electric power supply output terminal 25, the control input terminal 26, the control ground terminal 27, and the electric charging monitoring terminal 28 in the switch 15.

Additionally, the battery monitor 16 is connected to the BMS 13 through a communication network such as a CAN (Controller Area Network) in the watercraft 100. The battery monitor 16 monitors the status of the battery 12 and controls the switch 15 in accordance with the status of the battery 12. A charging control executed for the battery 12 by the battery monitor 16 will be hereinafter explained.

When the solar panel 11 generates electric power by sunlight, the generated electric power, outputted from the solar panel 11 to the electric charging input terminal 21, is inputted to the electric power supply circuit 29 through the electric charging input circuit 41. However, when the irradiation of the sunlight on the solar panel 11 is not effective and the voltage of the generated electric power outputted from the solar panel 11 is less than a threshold, the electric power supply circuit 29 does not supply the driving electric power to the battery monitor 16 so as not to activate the battery monitor 16.

When the irradiation of the sunlight on the solar panel 11 is effective and the voltage of the generated electric power outputted from the solar panel 11 is greater than or equal to the threshold, the electric power supply circuit 29 supplies the driving electric power to the battery monitor 16 through the electric power supply output circuit 43 and the electric power supply output terminal 25 so as to activate the battery monitor 16.

After being activated, the battery monitor 16 detects the voltage at the electric charging monitoring terminal 28. The battery monitor 16 determines whether or not the solar charging system 1 normally functions based on the voltage at the electric charging monitoring terminal 28. For example, the battery monitor 16 determines that the solar charging system 1 normally functions when the voltage at the electric charging monitoring terminal 28 is applied with Hi-Z (high impedance).

It should be noted that, when it is determined that the solar charging system 1 malfunctions, the battery monitor 16 stops the charging control for the battery 12. In this case, the battery monitor 16 may issue a warning. For example, the battery monitor 16 may turn on a warning lamp. Alternatively, the battery monitor 16 may cause a display in the watercraft 100 to show a warning screen.

When it is determined that the solar charging system 1 normally functions, the battery monitor 16 receives a signal, indicating whether electric charging is enabled or disabled for the battery 12, from the BMS 13. For example, when the battery 12 is excessively charged, the BMS 13 transmits a signal, indicating that electric charging is disabled for the battery 12, to the battery monitor 16.

When receiving a signal indicating that electric charging is enabled for the battery 12 from the BMS 13, the battery monitor 16 switches on the relay 30 in the switch 15. More specifically, the battery monitor 16 applies a Hi-voltage to the control input terminal 26. Accordingly, a base current for the transistor Q1 in the switching control circuit 44 flows such that a collector and an emitter are electrically conducted in the transistor Q1. Accordingly, a base current for the transistor Q2 flows such that a collector and an emitter are electrically conducted in the transistor Q2. As a result, a driving voltage is supplied to the drive circuit 47 in the relay 30 such that the relay 30 is switched on.

When the relay 30 is switched on, the generated electric power, outputted from the solar panel 11 to the charging input terminal 21, is outputted to the electric charging output terminal 23 through the electric charging input circuit 41 and the electric charging output circuit 45. Accordingly, the generated electric power outputted from the solar panel 11 is supplied to the battery 12 through the electric charger 14 such that electric charging is started for the battery 12.

When electric charging is started for the battery 12, a base current for the transistor Q3 in the electric charging monitoring circuit 46 flows such that a collector and an emitter are electrically conducted in the transistor Q3. The battery monitor 16 detects the voltage at the electric charging monitoring terminal 28. The battery monitor 16 determines whether the solar charging system 1 normally functions or malfunctions based on the voltage at the electric charging monitoring terminal 28. For example, when the voltage at the electric charging monitoring terminal 28 is supplied with a Hi-Z or Lo-Z (low impedance), the battery monitor 16 determines that the solar charging system 1 malfunctions.

When it is determined that the solar charging system 1 malfunctions, the battery monitor 16 switches off the relay 30. Likewise, when receiving a command to stop electric charging from the BMS 13, the battery monitor 16 switches off the relay 30 as well. For example, when the battery 12 has been fully charged or has malfunctioned, the BMS 13 transmits the command to stop electric charging to the battery monitor 16. When it is determined that the solar charging system 1 malfunctions or when receiving the command to stop electric charging from the BMS 13, the battery monitor 16 reduces voltage to be supplied to the control input terminal 26 to Lo-voltage. Accordingly, the transistors Q1 and Q2 are switched off such that the relay 30 is switched off. Consequently, electric charging is stopped for the battery 12.

When the irradiation of the sunlight on the solar panel 11 becomes ineffective and the voltage of the generated electric power outputted from the solar panel 11 becomes less than the threshold, the electric power supply circuit 29 does not supply the driving electric power to the battery monitor 16 so as to deactivate the battery monitor 16. Accordingly, the control input terminal 26 is not supplied with a voltage such that the relay 30 is switched off. While the relay 30 is being switched off, the generated electric power outputted from the solar panel 11 is not supplied to the electric charger 14. Thus, electric charging is stopped for the battery 12. When the irradiation of the sunlight on the solar panel 11 becomes effective again, the switch 15 and the battery monitor 16 execute again the series of processes described above such that electric charging is restarted for the battery 12.

In the solar charging system 1 according to the example embodiments explained above, the status of the battery 12 is monitored by the battery monitor 16. Then, the switch 15 is controlled to switch between whether or not to electrically charge the battery 12 in accordance with the status of the battery 12. Accordingly, excessive charging or degradation of the battery 12 is prevented. Additionally, the switch 15 is separate from the electric charger 14. Because of this, even when the electric charger 14 is of a low-cost type (e.g., a simple converter) without a function of controlling electric charging such as a function of controlling a voltage or a function of controlling a current, excessive charging or degradation of the battery 12 can be prevented.

Example embodiments of the present invention have been explained above. However, the present invention is not limited to the example embodiments described above and a variety of changes can be made without departing from the gist of the present invention.

The configuration of the outboard motor 3 is not limited to that in the example embodiments described above and may be changed. For example, the outboard motor 3 may include an electric motor instead of the engine 4. The configuration of the solar charging system 1 is not limited to that in the example embodiments described above and may be changed. For example, the circuit configuration of the switch 15 is not limited to that in the example embodiments described above and may be changed. The relay 30 is not limited to the SSR and may be another type of relay such as a mechanical relay.

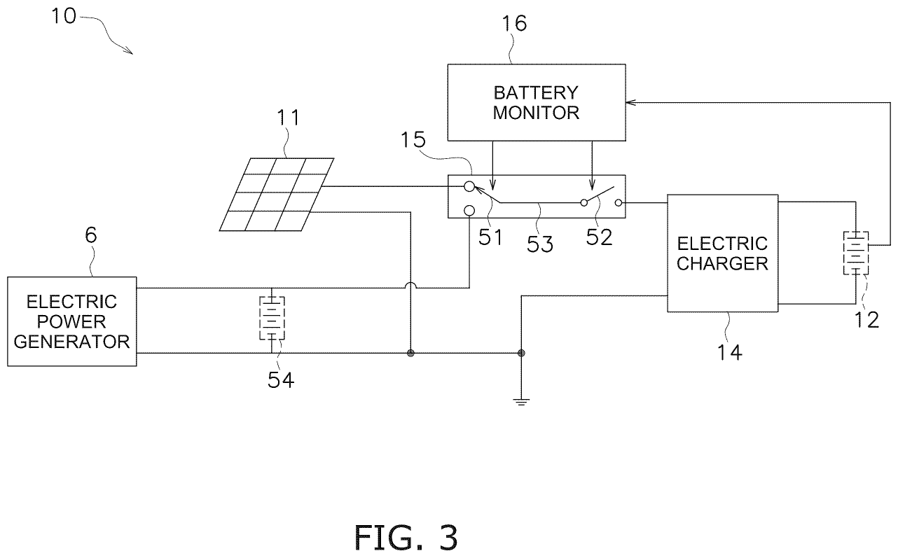

FIG. 3 is a diagram showing a configuration of a solar charging system 10 according to another example embodiment of the present invention. In the solar charging system 10 shown in FIG. 3, the electric charger 14 is connected to the solar panel 11 and the electric power generator 6 through the switch 15. The switch 15 includes a first relay 51, a second relay 52, and a connecting circuit 53. The first relay 51 is switchable between a first state and a second state. In the first state, the first relay 51 connects the connecting circuit 53 to the solar panel 11. In the second state, the first relay 51 connects the connecting circuit 53 to the electric power generator 6. The second relay 52 is switchable between an electric connection enabled state and an electric connection disabled state. In the electric connection enabled state, the second relay 52 allows electric connection of the connecting circuit 53 to the electric charger 14. In the electric connection disabled state, the second relay 52 shuts off electric connection of the connecting circuit 53 to the electric charger 14.

When it is determined that the battery 12 normally functions, the battery monitor 16 switches the second relay 52 into the electric connection enabled state. The battery monitor 16 selectively switches the first relay 51 into either the first state or the second state in accordance with the status of the solar panel 11 or that of the electric power generator 6. For example, when electric charging from the solar panel 11 is enabled for the battery 12, the battery monitor 16 switches the first relay 51 into the first state. Accordingly, the solar panel 11 is connected to the electric charger 14 through the switch 15 such that the battery 12 is charged by the generated electric power outputted from the solar panel 11. In this case, a second battery 54, provided as a device separate from the battery 12, may be charged by the generated electric power outputted from the electric power generator 6. It should be noted that the control to charge the battery 12 is herein executed in a comparable manner to that in the example embodiments described above.

When electric charging is disabled for the solar panel 11, and simultaneously, when the electric power generator 6 is being driven, the battery monitor 16 switches the first relay 51 into the second state. Accordingly, the electric power generator 6 is connected to the electric charger 14 through the switch 15 such that the battery 12 is charged by the generated electric power outputted from the electric power generator 6. As described above, the electric charger 14 may selectively switch between electric charging for the battery 12 from the solar panel 11 and that for the battery 12 from the electric power generator 6.

Additionally, when it is determined that the battery 12 malfunctions, the battery monitor 16 switches the second relay 52 into the electric connection disabled state. Accordingly, electric charging for the battery 12 from the solar panel 11 and that for the battery 12 from the electric power generator 6 are stopped.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A solar charging system for a watercraft, the solar charging system comprising:
a solar panel attached to the watercraft;
a battery;
an electric charger connected to the battery;
a switch separate from the electric charger, connected to the electric charger and the solar panel, and configured to switch between whether or not to electrically charge the battery in accordance with a status of the battery; and
a battery monitor configured to monitor the status of the battery and control the switch in accordance with the status of the battery.

2. The solar charging system according to claim 1, wherein the battery monitor is separate from the electric charger.

3. The solar charging system according to claim 1, wherein the battery monitor is separate from the switch.

4. The solar charging system according to claim 1, wherein
the switch includes an electric power supply circuit; and
the electric power supply circuit is configured to supply electric power to the battery monitor with electric power generated by the solar panel.

5. The solar charging system according to claim 4, wherein the electric power supply circuit is configured to supply the electric power to the battery monitor so as to activate the battery monitor when a voltage of the electric power generated by the solar panel is greater than or equal to a threshold such that electric charging is enabled for the battery.

6. The solar charging system according to claim 5, wherein the electric power supply circuit is configured to not supply the electric power to the battery monitor so as to deactivate the battery monitor when the voltage of the electric power generated by the solar panel is less than the threshold.

7. The solar charging system according to claim 1, further comprising:
an electric power generator; wherein
the electric charger is connected to the solar panel and the electric power generator through the switch.

8. The solar charging system according to claim 7, wherein the electric charger is configured to selectively switch between electric charging of the battery from the solar panel and electric charging of the battery from the electric power generator.

9. The solar charging system according to claim 8, further comprising:
an outboard motor attached to the watercraft; wherein
the electric power generator is located in or on the outboard motor.
